(19) United States
(12) Patent Application Publication
(10) Pub. No.: US 2024/0048565 A1
(43) Pub. Date: Feb. 8, 2024

(54) SYSTEM AND APPARATUS FOR GEOGRAPHICALLY TARGETED FRAUDULENT ACCESS MAPPING AND AVOIDANCE

(71) Applicant: Wells Fargo Bank, N.A., San Francisco, CA (US)

(72) Inventors: Robert Milden, Waxhaw, NC (US); Terri C. Kennell, Jacksonville, FL (US); Chemere Davis, Pineville, NC (US); Matt Hord, Denver, NC (US); Abhijit Rao, Irvine, CA (US)

(21) Appl. No.: 15/884,560

(22) Filed: Jan. 31, 2018

(51) Int. Cl. H04L 29/06; H04L 12/24

(52) U.S. Cl. CPC H04L 63/107; H04L 63/205; H04L 41/0816; H04L 63/123; H04L 63/302

(57) ABSTRACT

Embodiments are disclosed for performing a reconfiguration of a network-connected device based on the detection and mapping of unauthorized network access events at a location nearby or otherwise relevant to the network-connected device. An example method includes receiving location information associated with fraudulent network activity and receiving real-time and/or near-real-time data associated with such activity. The example method further includes responsively mapping a bounded geographic region within which network-connected devices may be at increased susceptibility for unauthorized activity and providing reconfiguration instructions to network-connected devices within that bounded geographic region. The example method further includes adjusting the rules under which a network-connected device operates within a given network based on a determination that the network-connected device has performed a requested reconfiguration to reduce the susceptibility of the network-connected device to fraudulent activity. Corresponding apparatuses and non-transitory computer readable storage media are also provided.

### TECHNOLOGICAL FIELD

Example embodiments of the present invention relate generally to the geographic mapping of fraudulent network access events and geographically targeted approaches to avoiding fraudulent network access events.

### BACKGROUND

The inventor has discovered problems with existing mechanisms for identifying and mapping geographic regions associated with fraudulent or otherwise unauthorized network access events and targeting efforts for hardening geographically proximate network devices from such unauthorized network access events. Through applied effort, ingenuity, and innovation, the inventor has solved many of these identified problems by developing solutions embodied by the present invention and described in detail below.

### BRIEF SUMMARY

Systems for the detection and geographic mapping of events and occurrences have many useful applications in a wide array of industries. As one example, event mapping systems can be used by law enforcement personnel to detect and track geographic concentrations and patterns in criminal activity and to deploy personnel based on the detected concentrations and patterns. As another example, event mapping systems can be used in connection with communication networks to identify geographic concentrations and patterns in network activity. Event detection and geographic mapping technology thus has potential to modify and/or inform how individuals, networks, and systems perform a wide range of activities in the future. In this regard, the benefits of event detection and geographic mapping technology are likely to be particularly valuable when used in environments involving communication networks to identify and predict use patterns.

However, the inventors have identified problems with existing event detection and mapping systems that limit the efficacy of such event detection and mapping systems, particularly in contexts involving the detection of unauthorized network access events, which include but are not limited to contexts where users seek to identify and map fraudulent network activity in connection with hardening other network access points against fraudulent activity. Existing event detection and mapping systems are generally ineffective at preventing fraudulent activity and other unauthorized network access events. This is especially true in contexts where the detection and mapping relies on aged data that reflects activity that occurred significantly before any detection and mapping activities take place. Conventional event detection and mapping systems are also ineffective in causing network access points in the geographic area surrounding locations at which fraudulent activity and/or other unauthorized network access events have occurred to become reconfigured to address localized and/or otherwise nearby fraudulent activity. This technical deficiency is compounded in situations where a third-party bears the risk associated with the resource misappropriation or misallocation caused by fraudulent activity and/or other unauthorized network access events, which effectively disincentivizes such network access points from taking any action. Further, conventional event detection and mapping systems are ineffective at informing potential users of network access points at or near a location where fraudulent activity and/or otherwise unauthorized network access events have occurred of the contemporaneous risks associated with a particular network access point.

Consequently, there is a need for advanced and improved event detection and mapping systems that are able to incorporate real-time and/or near-real-time data to assess and locate relevant activity. Likewise, there is a need for advanced and improved event detection and mapping systems that are capable of causing geographically targeted responses to nearby events. Further, there is a need for advanced and improved event detection and mapping systems that are capable of providing a user with an updated assessment of a network access point that reflects whether or not a response has been made to the detection of one or more relevant network events. These needs are particularly prevalent in system environments involving communications networks that are susceptible to fraudulent activity and/or otherwise unauthorized network access events.

Example embodiments described herein provide solutions to these problems, as well as others. In one example embodiment, methods, systems, and apparatus are provided for reducing unauthorized network access events that involve the determination of a bounded geographic region associated with an unauthorized network event and the identification of a network-connected device within that bounded geographic region. In some such example embodiments, and in other example embodiments, a reconfiguration instruction set based on the unauthorized network access event and the bounded geographic region associated with the unauthorized network access event is generated and transmitted to a network-connected device. In some such example embodiments, and in other example embodiments, a compliance verification procedure is performed on an event data set received from the network-connected device. In some such example embodiments, and in other example embodiments, a structured object, which may be used in connection with presenting information to a user via a user interface of a mobile device, for example, is generated to store an indication of one or more of the bounded geographic region, a geographic location associated with an unauthorized network access event and/or a location of a network-connected device.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings, which are not necessarily drawn to scale.

FIG. 1A illustrates an example environment in which some of the technical challenges overcome by some example embodiments described herein may be depicted and addressed.

FIG. 1B illustrates a system diagram of a set of devices that may be involved in some example embodiments described herein.

FIG. 2 illustrates a schematic diagram of the components of an example apparatus that may perform operations described herein, in accordance with some example embodiments described herein.

FIG. 3 illustrates a flowchart describing example operations performed by an apparatus in accordance with some example embodiments described herein.

FIG. 4 illustrates an example user interface that may be presented to a user in accordance with some example embodiments described herein.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### OVERVIEW

As noted above, methods, apparatuses, and systems are described herein that provide solutions to the problems identified above, as well as others. In one example embodiment, a network-connected device is identified within a bounded geographic region associated with an unauthorized network access event, and a reconfiguration instruction set, which may provide instructions and/or incentives for reconfiguring the network-connected device to become less susceptible to fraudulent activity and/or other unauthorized network access events, is generated for the network-connected device.

As noted herein, some example embodiments of the invention described and otherwise disclosed herein are particularly well-suited for use in environments involving a communications network. Some such environments may include a communications network used by a financial institution and/or other institution to receive and process payments, fund withdrawals, and/or other transactions. In such an environment involving a communications network used by a financial institution, many of the technical challenges described herein are compounded and exacerbated. Since the communications networks used by financial institutions and customers of those financial institutions are often designed to facilitate the purchase of goods and/or services, the transfer of funds, and even the withdrawal of funds, such networks are often targeted by individuals or groups who seek to misappropriate resources. As such, many of the examples presented herein use terminology and contextual description that relates to the communications networks used by financial institutions. However, it will be appreciated that example embodiments of the methods, systems, and apparatus presented herein are not limited to such contexts and environments, and may be implemented in a wide variety of system environments and contexts.

As used herein, the term “unauthorized network access event” refers to any action, activity, and/or set of actions or activities through which an individual, entity, and/or device attempts to access a network without the consent of an authorized network user. Fraudulent activity is one class of unauthorized network access events. In the context of communications networks used to interact with a payment system and/or financial institution, the class of fraudulent activity may encompass many different actions and/or activities, including but not limited to the use of stolen credentials (such as, for example, the use of genuine account numbers, credit cards, usernames, passwords, and/or other credentials that are stolen from a user and/or otherwise used without permission), the use of stolen user identities (such as, for example, the unauthorized use of biographical, personal, and/or other identification information to obtain credit accounts and/or other network access credentials), and/or the use of synthetic identities (such as the creation of a fictitious person or entity for the purposes of acquiring accounts and/or other network access credentials).

As used herein, the term “bounded geographic region” refers to any geographic area that can be identified with a closed boundary. Examples of bounded geographic regions include, but are not limited to, a state, city, zip code, closed set of identified city blocks, a set streets and/or other boundaries that define a closed area, a set of metes and bounds of one or more parcels of land, the geographic area within a predefined radius, and/or other delineation of a closed geographic area. It will be appreciated that the size, shape, and configuration of a bounded geographic region may vary depending on a number of factors, including but not limited to the characteristics of the underlying geography, the configuration of any relevant communications networks, and/or the type or types of unauthorized network access events.

As used herein, the term “network-connected device” refers to any device that is connected to a given communications network in a manner that allows the device to communicate in and/or otherwise interact with the network. For example, in the context of a communications network associated with a financial institution, a network-connected device may take the form of a network terminal, computer, mobile device, point-of-sale terminal, or the like.

As used herein, the term “reconfiguration instruction set” refers to any set of instructions that may be conveyed to a network-connected device and/or an individual and/or entity associated with a network-connected device that describes one or more changes to the structure, function, operations, and/or use of the network-connected device, the steps performed by the network-connected device, and/or any procedures performed in connection with the network connected device. For example, in some example implementations, a reconfiguration instruction set may include an identification of stolen credentials and/or other credentials used to fraudulently access a network (such a credentials obtained via identity theft and/or the use of a synthetic identity, for example). In some such example implementations, and in other example implementations, a reconfiguration instruction set may include updated device software, firmware, and/or hardware, and/or instructions related to such software, firmware, and/or hardware. In some such example implementations, and in other example implementations, the reconfiguration instruction set may include, for example updated procedures for use in connection with the network-connected device (such as procedures involved with multi-factor authentication or the like, for example).

As used herein, the term “network access rule set” refers to one or more rules that govern the interaction between a network-connected device and the relevant network. For example, in the context of a communications network associated with a financial institution, a network access rule set may include may govern the timing aspects, bandwidth limitations, fees, and/or other parameters governing the use by the network-connected device of the communications network and/or other services provide by the financial institution.

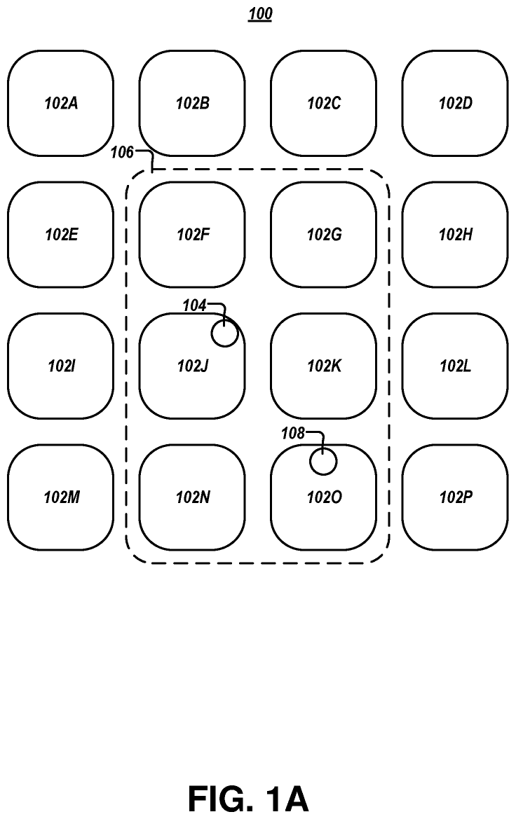

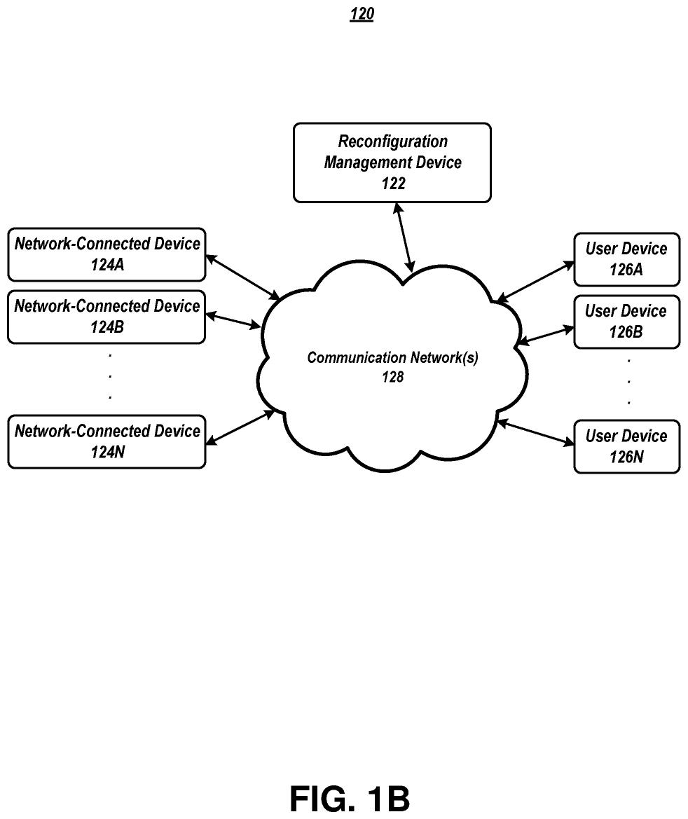

As shown in FIG. 1A, an example environment 100 is depicted in which some of the technical challenges described herein, and some of the example embodiments described herein that overcome such technical challenges, may be illustrated. In FIG. 1A, example environment 100 incorporates a geographic area where multiple city blocks, marked as blocks 102A-102P, are laid out in a grid pattern. It will be appreciated that while the particular example environment 100 shown in FIG. 1A depicts a portion of a city laid out in accordance with a grid system, other implementations may involve other geographic areas. In example environment 100, there may be multiple locations at which access to a given network may be achieved. For example, in the context of a communications network used to interact with a financial institution, there may be multiple point-of-sale devices, automated teller machines (ATMs), and/or other devices that are capable of interacting with the network to effect the purchase of goods and/or services, acquire or otherwise transfer funds, and/or otherwise perform transactions and/or information exchanges with a financial institution. One such network access point is shown in FIG. 1A as location 104.

In the example depicted in FIG. 1A, location 104, shown on block 102J, is a location at which fraudulent activity has been detected. In some example implementations, upon the detection of fraudulent activity at location 104, a bounded geographic region is determined. In the context of the example shown in FIG. 1A, this bounded geographic region is shown as region 106, which encompasses blocks 102F, 102G, 102J, 102K, 102N, and 102O. It will be appreciated that while region 106 is shown as encompassing a six-city-block area, the size and shape of the determined bounded geographic region may change, and may, in some situations be based at least in part on the underlying geography, information about the particular fraudulent activity and/or other unauthorized network access event, and/or other factors.

Regardless of its size, shape, and/or other configuration characteristics, after the bounded geographic region is determined, one or more network-connected devices within the bounded geographic region are identified. In FIG. 1A, one such network-connected device (which may be a point-of-sale terminal, an ATM, and/or other device connected to the network associated with the financial institution, for example) is shown as device 108, which is positioned on block 102O within bounded region 106. Upon identifying device 108, a reconfiguration instruction set is generated and transmitted to device 108. In some example implementations, the reconfiguration instruction set includes a set of instructions designed to reduce the susceptibility of device 108 to the type or types of fraudulent activity identified within the relevant bounded geographic area. For example, in situations where the fraudulent activity at location 104 involves the use of a synthetic identity to fraudulently acquire a credit account, the reconfiguration instruction set may include an identification of the synthetic identity and/or related account information and steps that may be taken to ensure that the synthetic identity and/or related credit account are not able to perpetrate further fraudulent activity via device 108. In another example, such as when the fraudulent activity detected at location 104 involves techniques and/or actions used to perpetrate the misappropriation of funds and/or the other misallocation of resources, the reconfiguration instruction set may include instructions and/or other information that can be used to reconfigure device 108 to limit its vulnerability to attack via those techniques and/or actions.

As noted herein, one of the significant technical challenges involved with event detection systems (beyond those associated with identifying particular network events and mapping such events) involves incentivizing entities to undertake preventative measures (such as device and/or system reconfigurations, for example) and confirming that such preventative measures have been taken and maintained. In some example implementations that can be performed in environment 100, after the transmission of the reconfiguration instruction set to device 108, a determination of whether device 108 had performed a reconfiguration in accordance with the instruction set is performed. In some instances, this may take the form of receiving information from the device 108 and performing a compliance verification procedure designed to ascertain whether the previously received reconfiguration instructions have been followed. In some situations, it may be advantageous to periodically and/or randomly repeat one or more compliance verification procedures for device 108 to confirm that potentially importance device reconfigurations have been maintained over time.

In order to incentivize users, operators, and/or other entities associated with devices such as device 108 to perform and maintain the reconfiguration or reconfigurations included in reconfiguration instruction sets, some example implementations involve changing a network access rule set associated with the network-connected device. For example, upon determining that the device 108 has performed a reconfiguration in accordance with a reconfiguration instruction set, the rules governing the speed with which transactions are processed by the communications network, the fees charged for use of the communications network, and/or the set of services provided to the network-connected device (and/or an entity associated with the network-connected device) may be adjusted to reflect the reduction in the susceptibility of the network-connected device to fraudulent activity.

FIG. 1B illustrates a system diagram of a set of devices within a network environment that may be involved in some example embodiments described herein. In this regard, FIG. 1B discloses an example environment 120 within which embodiments of the present disclosure may operate to detect unauthorized network access events and effect the reconfiguration of one or more network-connected devices. As illustrated, a reconfiguration management device 122 may be connected to one or more network-connected device 124A-124N (which may take the form of a network terminal, computer, mobile device, point-of-sale terminal, or the like, or any of the other types of devices referenced and/or contemplated in connection with the network-connected devices described herein) and one or more user devices 126A-126N (by which one or more users may obtain and interact with information regarding one or more network-connected devices, unauthorized network access events, or the like, for example) through one or more communications networks 128. In some embodiments, the reconfiguration management device 122 may be configured to facilitate the detection and mapping of one or more network events as well as the reconfiguration of one or more network-connected devices, as described in further detail below.

The reconfiguration management device 122 may be embodied as one or more computers or computing systems as known in the art. In some embodiments, the reconfiguration management device 122 may provide for receiving and/or providing data objects and/or other data sets to and from various sources, including but not necessarily limited to the network-connected devices 124A-124N, the user devices 126A-126N, or both. For example, the reconfiguration management device 122 may receive data objects and/or data sets associated with fraudulent activity and/or other unauthorized network access events from a network-connected device, such as a network-connected device 124A, which may be associated with location 104 in FIG. 1A. The reconfiguration management device 122 may also provide data objects and/or other data sets, such as a reconfiguration instruction set, to a network-connected device, such as a network-connected device 124B, which may be an implementation of device 108 described in connection with FIG. 1A. The reconfiguration management device 122 may also be configured to communicate with one or more user devices 126A-126N (which may be embodied by any computing device known in the art, including but not limited to laptop computers, smartphones, netbooks, tablet computers, wearable devices, desktop computers, electronic workstations, or the like, for example) to provide information about one or more network-connected devices 124A-124N, scores associated with such network-connected devices 124A-124N, and/or information about one or more unauthorized network access events.

As shown in FIG. 1B, the reconfiguration management device 122, the network-connected devices 124A-124N, and the user devices 126A-126N are configured to communicate with each other and otherwise interact with one or more communications networks 128. It will be appreciated that communications networks 128 may take the form of any wired and/or wireless networks suitable for enabling communication between one or more of the devices described herein. In some example implementations, the reconfiguration management device 122 and the network-connected devices 124A-124N interact via a communication network that is associated with a financial institution and/or otherwise configured to facilitate the exchange of information associated with the purchase of goods and/or services, the transfer of funds and/or other resources and/or the performance of one or more transactions. As such, in some of the examples described herein, the network environment 120 depicted in FIG. 1B may be incorporated in the physical environment 100 depicted in FIG. 1A to enable devices shown or otherwise contemplated in FIG. 1A to interact with the network environment 120, and for operations performed within the network environment 120 of FIG. 1B to be reflected in the physical environment 100 of FIG. 1A.

Greater detail is provided below regarding certain example embodiments contemplated herein.

### Device Architecture

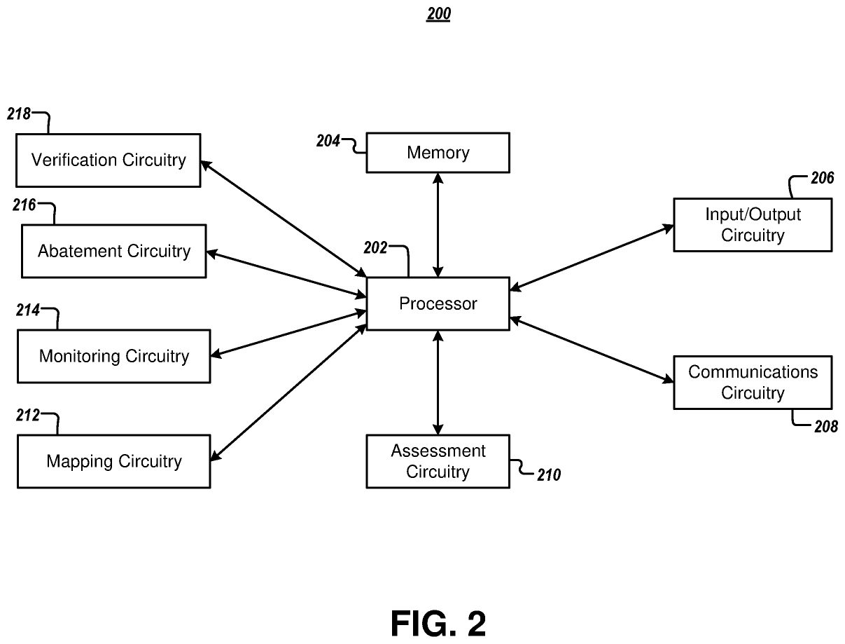

Apparatuses of the present invention may be embodied by any of a variety of devices. For example, the apparatus performing improved network event identification, mapping, and response may include any of a variety of fixed terminals, such a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein (including but not limited to reconfiguration management device 122), may have various form factors and designs, but will nevertheless include at least the components illustrated in FIG. 2 and described in connection with example apparatus 200.

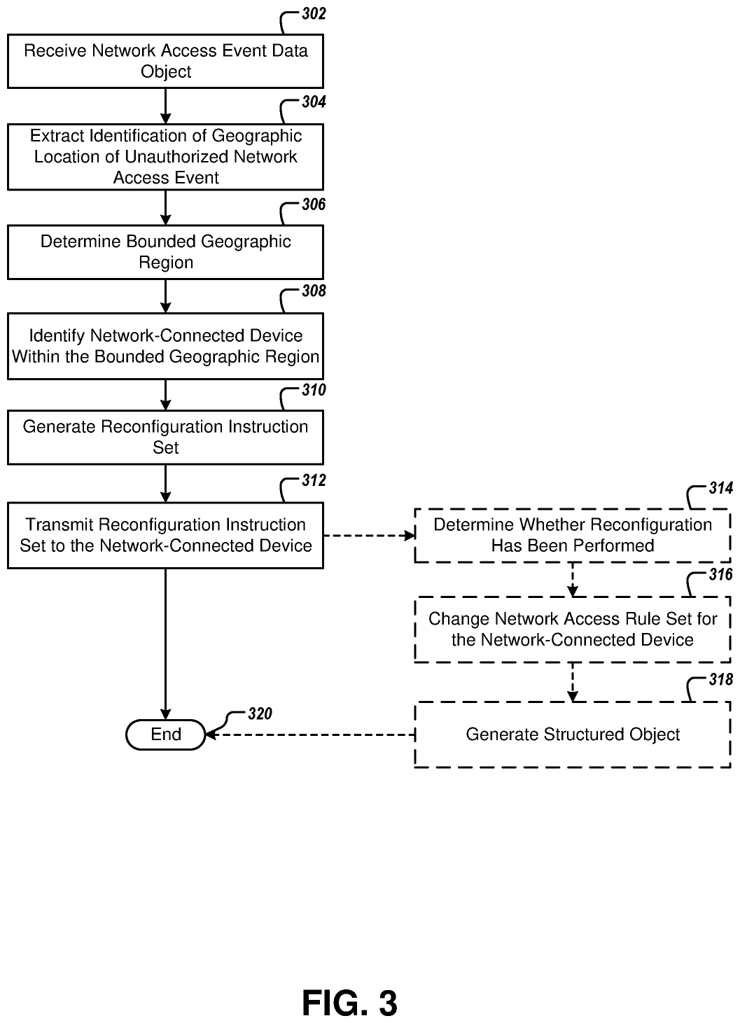

As illustrated in FIG. 2, the apparatus 200 may include a processor 202, a memory 204, input/output circuitry 206, and communications circuitry 208. Moreover, apparatus 200 may include assessment circuitry 210, mapping circuitry 212, monitoring circuitry 214, abatement circuitry 216, and verification circuitry 218. The apparatus 200 may be configured to execute the operations described below in connection with FIG. 3. Although these components 202-218 are described in some cases using functional language, it should be understood that the particular implementations necessarily include the use of particular hardware. It should also be understood that certain of these components 202-218 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein with respect to components of the apparatus therefore includes particular hardware configured to perform the functions associated with respective circuitry described herein.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the apparatus 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor 202. Alternatively or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

The apparatus 200 further includes input/output circuitry 206 that may, in turn, be in communication with processor 202 to provide output to the user and to receive input from a user or another source. In this regard, the input/output circuitry may comprise a user interface and/or other interface that allows for the receipt and output of information relating to unauthorized network access events. Separately, the input/output circuitry 206 may comprise a display that may be manipulated by a mobile application. In some embodiments, the input/output circuitry 206 may also include additional functionality keyboard, a mouse, a joystick, a touch screen, touch areas, soft keys, a microphone, a speaker, or other input/output mechanisms. The processor 202 and/or user interface circuitry comprising the processor 202 may be configured to control one or more functions of display through computer program instructions (e.g., software and/or firmware) stored on a memory accessible to the processor (e.g., memory 204, and/or the like), such as to receive and produce data associated with network access events and related geography.

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the apparatus 300 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

Assessment circuitry 210 includes hardware components designed to extract, from a data object containing information about a network access event, information identifying one or more geographic locations associated with an unauthorized network access event. These hardware components may, for instance, utilize elements of input/output circuitry 206 to parse a received network access event data object, and memory 204 to retrieve a stored set of geographic information and/or a stored set of information relating to one or more types of unauthorized network access events. Assessment circuitry 210 may utilize processing circuitry, such as the processor 202, to perform the above operations, and may utilize memory 204 to store collected information.

Mapping circuitry 212 includes hardware components designed to perform a mapping process through which a bounded geographic region is determined based at least in part on a geographic location associated with an unauthorized network access event. These hardware components may, for instance, utilize elements of input/output circuitry 206 to detect the location associated with the unauthorized network access event and characteristics of the unauthorized network access event, and memory 204 to retrieve stored mapping information, including but not limited to information about the underlying geography which may inform the size, shape, and configuration of the bounded geographic region to be established. Mapping circuitry 212 may utilize processing circuitry, such as the processor 202, to perform its corresponding operations, and may utilize memory 204 to store collected information.

Monitoring circuitry 214 includes hardware components designed to identify one or more network-connected devices located within the bounded geographic region associated with the unauthorized network access event. These hardware components may, for instance, utilize elements of input/output circuitry 206 to determine the area encompassed within the boundaries of the bounded geographic region, and memory 204 to retrieve a stored record of a network-connected device located within the relevant bounded geographic region. Monitoring circuitry 214 may utilize processing circuitry, such as the processor 202, to perform its corresponding operations, and may utilize memory 204 to store collected information.

Abatement circuitry 216 includes hardware components designed to generate a reconfiguration instruction set based on the unauthorized network access event and the bounded geographic region associated with the unauthorized network access event. These hardware components may, for instance, utilize elements of input/output circuitry 206 to receive real-time information, near-real-time information, and/or other information regarding the unauthorized network access event and/or the bounded geographic region. The hardware components of abatement circuitry 216 may also interact with memory 204 to retrieve information about a given network-connected device, the network access rules associated with the network-connected device, and/or reconfigurations of the network-connected device that would reduce the susceptibility of the network-connected to device to one or more aspects of the unauthorized network access event. Abatement circuitry 216 may utilize processing circuitry, such as the processor 202, to perform the above operations, and may utilize memory 204 to store collected information.

Verification circuitry 218 includes hardware components designed to determine whether a network-connected device has performed a reconfiguration in accordance with a received reconfiguration instruction set. These hardware components may, for instance, utilize elements of input/output circuitry 206 and/or communications circuitry 208 to receive one or more event data sets from a network-connected device that has previously received a reconfiguration instruction set and perform one or more tests or other compliance verification procedures to determine whether the reconfiguration has been implemented at the network connected device. The hardware components of verification circuitry 218 may also interact with memory 204 to retrieve information about a given network-connected device, the network access rules associated with the network-connected device, and/or reconfigurations of the network-connected device that have been performed by the network-connected device. Verification circuitry 218 may utilize processing circuitry, such as the processor 202, to perform the above operations, and may utilize memory 204 to store collected information.

It should also be appreciated that, in some embodiments, the assessment circuitry 210, mapping circuitry 212, monitoring circuitry 214, abatement circuitry 216, and verification circuitry 218 may include a separate processor, specially configured field programmable gate array (FPGA), or application specific interface circuit (ASIC) to perform its corresponding functions.

In addition, computer program instructions and/or other type of code may be loaded onto a computer, processor or other programmable apparatus's circuitry to produce a machine, such that the computer, processor other programmable circuitry that execute the code on the machine create the means for implementing the various functions, including those described in connection with the components of apparatus 200.

As described above and as will be appreciated based on this disclosure, embodiments of the present invention may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

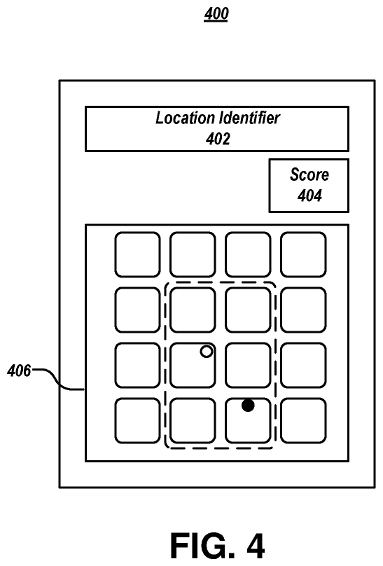

Having described specific components of example apparatuses 200, and in connection with FIGS. 1A, 1B, and 2, an example procedure is described below in connection with FIGS. 3 and 4 for the improved reconfiguration of a network-connected device in response to the detection and mapping of an unauthorized network access event.

### Example Operations for Improved Network-Connected Device Reconfiguration in Response to the Detection and Mapping of an Unauthorized Network Access Event

Turning to FIG. 3, a flowchart is illustrated that contains operations for using an apparatus to perform reconfigurations of one or more network-connected devices in a more efficient and effective manner than has been provided by existing technologies. The operations illustrated in FIG. 3 may, for example, be performed by an apparatus 200 as described above, such that the operations described herein may be performed by or through the use of one or more of processor 202, memory 204, input/output circuitry 206, communications circuitry 208, assessment circuitry 210, mapping circuitry 212, monitoring circuitry 214, and/or abatement circuitry 216.

Operation 302 is the first operation in the procedure illustrated in FIG. 3. With respect to operation 302, the apparatus 200 includes means, such as processor 202, memory 204, input/output circuitry 206, communications circuitry 208, assessment circuitry 210, mapping circuitry 212, monitoring circuitry 214, and/or the like, for receiving a network access event data object that comprises data indicative of, or otherwise identifies, an unauthorized network access event and a geographic location associated with the unauthorized network access event. For example, the network access event data object may include a field configured to indicate a presence, or in some embodiments a type of an unauthorized network access event and in those instances in which the presence and/or type is indicated, one or more other fields may comprise location information, such as for example, data indicative of a latitude and longitude (e.g., GPS coordinates, or the like), a network name or ID, etc. In example implementations of operation 302, a network access event data object is received by the communications circuitry 208 of the apparatus 200. A network access event data object may be configured as a structured data object that contains a set of data about a given unauthorized network access event and a geographic location associated with that network access event. The information underlying the set of data about a given unauthorized network access event may come from any of one or more of a variety of sources, including but not limited to real-time and/or near-real-time data streams (such as those that may be available from fraud detection systems operated by a financial institution associated with a given communications network, for example) and/or other data sources that may provide information in accordance with different time schedules. In some example implementations, real-time and/or near-real-time data streams (such as those that may be available from fraud monitoring systems used by a financial institution and/or other entity, for example), are monitored and/or periodically accessed by the apparatus 200 and/or another system configured to identify information within the data streams that relates to an unauthorized network access event and extract such data from the data streams. The extracted data may then be incorporated into a network access data object for subsequent transmission and processing by the apparatus 200.

It will be appreciated that the sources of information used to provide data for a given network access event data object may vary based on the characteristics of a given network and/or unauthorized network access event. In some contexts, including but not limited to those involving communications networks associated with a financial institution, a network event data object that is used to hold data associated with detected fraudulent activity may incorporate data received from systems associated with a given financial institution and/or other financial institutions, police reports, litigation records, insurance claims, transaction information, health inspection reports, vendor data, customer reviews, social media sources, business publications (including but not limited to publications reporting data breaches and/or other business violations, for example), and reports from other entities such as the local Better Business Bureau, and the like, for example. In example implementations where the network access event data object includes information received in real-time and/or near-real-time, and is received by the apparatus 200 via the communications circuitry 208 in real-time and/or near-real-time, the underlying unauthorized network access event may be rapidly mapped and/or otherwise used to cause reconfigurations in nearby network-connected devices. In doing so, such example implementations address the delays inherent in many existing event mapping systems that are incapable of responding in real-time or near-real-time to unauthorized network access events.

In addition to information identifying an unauthorized network access event, a network access event data object also includes an identification of a geographic location associated with the unauthorized network access event. The identification of the geographic location associated with the unauthorized network access event may be expressed in any form capable of identifying the relevant location. For example, in some implementations, the identification of the geographic location may be expressed as a street address, a set of Global Positioning System coordinates, and set of latitude and longitude coordinates, or the like. Regardless of the format of the information contained within the network access event data object, upon receipt of the network access event data object, the communications circuitry 208 of the apparatus 200 may pass the network event data object to the assessment circuitry 210, store the network access event data object in memory 204, and/or may otherwise pass the network access event data object to other circuitry in apparatus 200 for further processing.

After the receipt of the network access event data object as described in connection with operation 302 is performed in a given circumstance, the procedure illustrated in FIG. 3 then advances to operation 304. At operation 304, the apparatus 200 includes means, such as assessment circuitry 210 or the like, for extracting from the network access event data object information identifying the geographic location associated with the unauthorized network access event. In this regard, assessment circuitry 210 may most commonly comprise circuitry configured to (either independently and/or in conjunction with other aspects of apparatus 200, such as the processor 202, for example) parse the network access event data object and copy and/or otherwise extract the information identifying the geographic location associated with the unauthorized network access event. Upon extraction of the information identifying the geographic location associated with the unauthorized network access event, the assessment circuitry 210 of the apparatus 200 may pass the extracted location information to the mapping circuitry 212, store the extracted location information in memory 204, and/or may otherwise pass the extracted location information to other circuitry in apparatus 200 for further processing.

Turning next to operation 306, the apparatus 200 includes means, such as mapping circuitry 212 or the like, for determining, based at least in part on the geographic location associated with the unauthorized network access event, a bounded geographic region associated with the unauthorized network access event. In this regard, the mapping circuitry 212 is configured to make this determination based on one or more factors, including but not limited to the geographic location associated with the unauthorized network access event and, in some example implementation, the additional information contained within the network access event data object. As discussed in connection with the bounded geographic region 106 in FIG. 1A, the bounded geographic region may be characterized by different sizes, shapes, and/or other characteristics based on the underlying geography and/or the underlying unauthorized network access event.

In some example implementations, the mapping circuitry attempts to define a bounded geographic region such that the bounded geographic region encompasses an area within which there is an increased probability that fraudulent activity and/or other unauthorized network access events similar to the unauthorized network access event identified in the network access event data object may occur. For instance, the characteristics of the underlying geography and in some embodiments, infrastructure, contributing to the speed and/or relative ease with which an individual engaging in fraudulent activity may move from one place to another, may cause the mapping circuitry to assign a particular size and shape to the bounded geographic region. By way of another example, characteristics of the underlying fraudulent activity and/or other unauthorized network access event may cause the mapping circuitry to assign a particular size and shape to the bounded geographic region. In some example implementations, the mapping circuitry 212 may interact with the processor 202, memory 204, and/or other components of the apparatus to access information about the underlying unauthorized network access event, the underlying geography, and/or any predetermined rules governing the size, shape, configuration, and/or other characteristics of a bounded geographic region to be identified and/or otherwise determined in a given situation.

In one example implementation, a bounded geographic region is determined by applying a predefined radius to establish a region centered on the location associated with the unauthorized network access event. In such an example implementation, the mapping circuitry 212 may interact with the processor 202 and memory 204 to consult a table stored in memory 204 containing the lengths of one or more predefined radii. It will be appreciated that the radius length obtained from the table may take into account characteristics of the underlying geography and/or characteristics of the underlying unauthorized network access event, such that the radius used in connection with one particular unauthorized network access event in one particular location may be longer or shorter (and thus establish a larger or smaller bounded geographic region) than the radius used in connection with another particular unauthorized network access event in another particular location. In other example implementations, different shapes (such as rectangular and other polygonal shapes, for example) may be used, and more sophisticated approaches may be taken in other example implementations. For example, mapping circuitry 212 (either alone or in conjunction with other circuitry in the apparatus 200) may be capable of identifying characteristics of the location associated with a given unauthorized network access event and apply specialized, rules-based approaches to determining the bounded geographic region. For example, upon determining that an unauthorized network access event occurred within a shopping mall, shopping district, and/or larger commercial district, the mapping circuitry 212 may define the bounded geographic region to encompass all or part of the relevant mall, shopping district, and/or larger commercial district.

Regardless of the approach used to determine the bounded geographic region, Upon the determination of the bounded geographic region, the mapping circuitry 212 of the apparatus 200 may pass information regarding the bounded geographic region to the monitoring circuitry 214, store the parameters of the bounded geographic region (and/or other information about the bounded geographic region) in memory 204, and/or may otherwise pass information about the bounded geographic region to other circuitry in apparatus 200 for further processing.

As shown at operation 308, the apparatus 200 includes means, such as monitoring circuitry 214, for identifying a network-connected device within the bounded geographic region. As noted herein, example implementations of the methods, systems, and apparatus described herein overcome many of the technical challenges associated with conventional event detection systems by identifying network-connected devices that are located in areas where there may be an increased risk of one of more types of fraudulent activity and/or other unauthorized network access events, and causing those network-connected devices to engage in reconfigurations that reduce their susceptibility to the relevant activity. In some example implementations, monitoring circuitry 214 interacts with the processor 202, memory 204, assessment circuitry 210, input/output circuitry 206, and/or communications circuitry 208 to identify network connected devices within the bounded geographic region determined in connection with operation 306. In some instances, identifying one or more network-connected devices may include acquiring a list of relevant devices from memory 204 and/or an external system. In other instances, monitoring circuitry 214 may test location information associated with one or more network devices against the boundaries of the bounded geographic region to ascertain whether a given network-connected device is inside or outside the bounded geographic region.

Upon the identification of a network-connected device within the bounded geographic region in operation 308, the process depicted in FIG. 3 proceeds to operation 310. As shown by operation 310, the apparatus 200 includes means, such as abatement circuitry 216, for generating a reconfiguration instruction set based on the unauthorized network access event and the bounded geographic regions associated with the unauthorized network access event. As discussed herein, example implementations of the methods, systems, and apparatus described herein reduce fraudulent activity by causing reconfigurations of network devices that are located in regions near where fraudulent activity has been detected. In situations where real-time and/or near-real-time data is used to identify fraudulent activity and/or other unauthorized network access events, the rapid reconfiguration of network-connected devices may effectively curtail the spread of fraudulent activity before the activity spreads widely through a network. In some instances, abatement circuitry 216 may interact with the processor 202, memory 204, input/output circuitry 206 and/or communications circuitry 208 to obtain information describing the current configuration of one or more relevant network-connected devices, so that a determination of the susceptibility of the network-connected device to one or more types of fraudulent activity may be performed, such as by the apparatus 200. For example, abatement circuitry 216 may ascertain that a given network-connected device is currently configured to attempt to process any transaction involving a plastic card (such as a credit or debit card) without taking any steps to verify the identity of the presenter of the card. To harden the network-connected device against activity involving stolen plastic cards and/or plastic cards obtained through the use of a stolen identity or synthetic identity, the reconfiguration instruction set may include instructions for reconfiguring the network-connected device to delay attempting to process a transaction until an operator of the network-connected device enters information confirming the identity of the presenter of the card. In another example implementation, the reconfiguration instruction set may include a list of identities and/or account numbers that have been classified as stolen and/or otherwise fraudulent, such that the network-connected device denies attempted transactions involving those identities and/or account numbers.

Any of the reconfiguration instruction sets described or contemplated herein may be generated by the abatement circuitry 216 and/or other components of apparatus 200. In some example implementations, the reconfiguration instruction set includes a set of authentication protocols associated with the unauthorized network access event. For example, the reconfiguration instruction set may provide instructions describing one or more procedures (such as two-factor authentication procedures, or the like, for example) that are designed to reduce the susceptibility of the network-connected device to fraudulent activity. In some example implementations, the reconfiguration instruction set may include an identification of the steps that entities engaged in fraudulent activity attempt to perform in furtherance of the fraudulent activity. By way of another example, the reconfiguration instruction set may include a set of network authentication credentials associated with the unauthorized network access event. In some such example implementations, the set of network authentication credentials may include one or more of a name used in connection with fraudulent activity, account numbers and/or other credentials used in connection with fraudulent activity (such as stolen account information and/or account information obtained through the use of a stolen and/or synthetic identity, for example). In some example implementations, to generate a reconfiguration instruction set, the abatement circuitry 216 retrieves from memory 204 information about the current configuration of a network connected device and a predetermined reconfiguration instruction set that is associated with the network-connected device and/or one or more categories of unauthorized network access events. In other example implementations, the abatement circuitry 216 either alone or in conjunction with the input/output circuitry 206 and/or the communications circuitry 208, requests and/or otherwise acquires configurations from network-connected devices in other locations that have previously been reconfigured to reduce their susceptibility to fraudulent activity similar to the relevant unauthorized network access event. Upon receiving configuration information (either through retrieving such information from the memory 204 and/or through the receipt of configuration information from sources remote to apparatus 200, for example) the abatement circuitry 216 may transform and/or otherwise modify the configuration information for transmission to the relevant network-connected device.

Upon the generation of a reconfiguration instruction set in operation 310, the process depicted in FIG. 3 progresses to operation 312. As illustrated at operation 312, the apparatus 200 includes means, such as communications circuitry 208 and/or input/output circuitry 206 for causing the transmission to the network-connected device of the reconfiguration instruction set. Since the network-connected device is, by definition, configured to communicate via a relevant communications network, the apparatus 200 may transmit the reconfiguration instruction set to the network-connected device via the relevant communications network and/or through other channels. In some example implementations, causing the transmission of the reconfiguration instruction set may involve causing the initiating of an installation of the reconfiguration instruction set by the network-connected device. For example, the reconfiguration set and/or commands and/or information sent in connection with a transmission of a reconfiguration instruction set may prompt a user to install the reconfiguration instruction set on one or more network-connected devices and/or may cause a network-connected device to automatically initiate installation of the reconfiguration instruction set. As shown in FIG. 3, upon causing the reconfiguration instruction set to be transmitted to the network-connected device, the process shown in FIG. 3 may end, as shown by block 320. In some example implementations, however, one or more of the optional operations depicted as operations 314, 316, and/or 318 may be performed.

As illustrated at operation 314, the apparatus 200 includes may optionally include means, such as communications circuitry 208, input/output circuitry 206, the processor 202, and/or abatement circuitry 216 for determining, after the transmission of the reconfiguration instruction set, if the network-connected device has performed a reconfiguration in accordance with the reconfiguration instruction set. In some example implementations, the apparatus 200, such as through the operation of input/output circuitry 206 and/or communications circuitry 208, may request and/or receive information from the network-connected device and test that received information against the instructions contained in the reconfiguration instruction set. In some example implementations, determining whether the reconfiguration has been performed by the network-connected device may comprise receiving an event data set from the network-connected device and performing a compliance verification procedure on the received event data set. It will be appreciated that the content of the event data set and/or the details of the compliance verification procedure may vary based on the characteristics of the network-connected device and the relevant reconfiguration instruction set.

For example, in instances where the reconfiguration instruction set involves a change in settings and/or other aspects of a network-connected device, the apparatus 200 may receive an indication from the network-connected device demonstrating that the requested settings and/or other aspects have been reconfigured. In instances where the reconfiguration instruction set involved instructions for new procedures to be used in connection with the network-connected device, the event data set may include transaction information and/or other data demonstrating that the new procedures have been used. In some example implementations, the results of a compliance verification procedure performed in connection with a reconfiguration instruction set for a particular network connected device may be used by the apparatus 200 to generate a score associated with the network-connected device. In some example implementations, the score is associated with the susceptibility of the network-connected device to one or more types of fraudulent activity and/or other unauthorized network access events. For example, the score associated with the network-connected device may be generated by the processor 202 of apparatus 200, and may generally reflect a scaled combination of data values assigned to the results of the compliance verification procedure, and may, in some example implementations, incorporate data values associated with the relevant geography, nearby fraudulent activity, and/or other characteristics of the network-connected device.

It will be appreciated that the apparatus 200 may also be configured to take into account the failure of a network-connected device to perform a reconfiguration in accordance with the relevant reconfiguration instruction set. In some such example implementations, the apparatus 200 may add an identification of the network-connected device to an index of non-compliant devices. Such an index may be stored, for example, in memory 204, and, in some example implementations, the presence of an identification of a given network-connected device on the index may have a negative impact on a score assigned to the network-connected device.

As discussed herein, some example implementations of the methods, systems, and apparatus described herein overcome the technical challenges experienced by conventional event detection systems by incentivizing network-connected devices that may not be directly impacted by a given set of fraudulent activity and/or other unauthorized network access event to engage in a reconfiguration to reduce the susceptibility of the network-connected device to the relevant fraudulent activity and/or other unauthorized network access event. As such, and as depicted at optional operation 316, the apparatus 200 includes may optionally include means, such as communications circuitry 208, input/output circuitry 206, the processor 202, and/or abatement circuitry 216 for changing a network access rule set associated with the network-connected device. In some example implementations, the change of the network access rule set may take the form of reduced fees charged for the use of the relevant communications network and/or services provided by a financial institution and/or other service provider, or improved network service (such as the expansion of bandwidth allocated to the network-connected device and/or an increase in the speed with which communications and/or transactions performed via the communications network by the network-connected device are performed.

It will be appreciated that, particularly in situations where the apparatus 200 is capable of receiving and/or processing information in real-time and/or near-real-time, the status of a network-connected device may be periodically checked, and the incentives provided to the network-connected device may be adjusted. For example, the apparatus 200 may subject a given network-connected device to multiple compliance verification procedures over time to confirm that reconfigurations have been maintained. Moreover, in some example implementations, the ability of the apparatus 200 to process information in real-time and/or near-real-time permits the apparatus 200 to adjust the network access rule set and/or other incentives for the network-connected device to reflect changes in the activity patterns in a given area and/or changes in the characteristics of the network-connected device.

As discussed herein, some example implementations of the methods, systems, and apparatus described herein overcome the technical challenges experienced by conventional event detection systems by providing information to users (such as potential customers of entities associated with network-connected devices, for example) to readily ascertain information pertaining to the susceptibility of a given network-connected device to fraudulent activity. In situations where customers are able to identify locations at which their account information, identity, and/or otherwise sensitive information may be at risk for misuse and/or misappropriation, those customers may be able to weigh the risk and/or take appropriate protective measures. As such, and as depicted at optional operation 318, the apparatus 200 includes may optionally include means, such as communications circuitry 208, input/output circuitry 206, the processor 202, mapping circuitry 212, and/or the like for generating a structured object storing an indication of one or more of the bounded geographic region associated with the unauthorized network access event, the geographic location associated with the unauthorized network access event, or a location of the network-connected device. In some example implementations, the structured data object may be stored, and used in connection with rendering an image that can be presented to a user (such as through the screen of a user's mobile device, for example). An example of such an image 400 which may be presented to a user is shown in FIG. 4.

In the example image 400 shown in FIG. 4, a location identifier 402 may be used to identify a network-connected device. In some example implementations, the location identifier 402 may include a name, street address, and/or other identification of a given network-connected device. In example implementations of image 400 that arise in contexts where a score has been determined for the network-connected device, that score may be presented to the user, as shown in FIG. 4 as example element 404. FIG. 4 also contemplates that additional information may be presented to the user. In the example image 400 presented in FIG. 4, image element 406 includes a map, similar to that presented in FIG. 1A, that may provide, for example, a graphical depiction of a given network-connected device, one or more bounded geographic regions around or near the network-connected device, and/or the a location associated with one or more unauthorized network access events. It will be appreciated that other elements may be included in other implementations, of image 400, such as textual information and/or other content that may be of interest to a user and/or otherwise provide information regarding the prevalence of fraudulent activity in a given area and the susceptibility of one or more network-connected devices to such activity.

As described herein, example embodiments thus provide many benefits to event detection systems that have heretofore gone unrealized. Example embodiments described herein provide an event detection and mapping system that efficiently uses location information and/or other information associated with fraudulent activity and/or other unauthorized network access events to incentivize and otherwise cause the reconfiguration of nearby network-connected devices to reduce their respective susceptibility to the detected fraudulent and/or otherwise unauthorized activity. In addition, some example embodiments utilize an apparatus configured for changing the rules under which a network-connected device interacts with a given communications network as a mechanism to incentive particular reconfigurations at a network-connected device. And finally, some example embodiments contemplate the use of information receive in real-time and/or near-real-time to facilitate the rapid hardening of network-connected devices to nearby fraudulent activity and to provide updated information to users regarding the risk of fraudulent activity in a given area.

FIG. 3 thus illustrates a flowchart describing the operation of apparatuses, methods, and computer program products according to example embodiments contemplated herein. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 204 of an apparatus 200 and executed by a processor 202 of the apparatus 200. As will be appreciated, any such computer program instructions may be loaded onto a computer or other programmable apparatus (e.g., hardware) to produce a machine, such that the resulting computer or other programmable apparatus implements the functions specified in the flowchart blocks.

These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for dynamically disseminating, for installation at network-connected devices, reconfiguration instruction sets aimed at reducing unauthorized network access events, the method comprising:
receiving, by communications circuitry of an apparatus, a network access event data object from a first network-connected device, wherein the network access event data object identifies a type of an unauthorized network access event and a geographic location associated with the type of unauthorized network access event;
extracting, by assessment circuitry of the apparatus and from the network access event data object, information identifying the geographic location associated with the type of unauthorized network access event;
determining, by mapping circuitry of the apparatus, a unique bounded geographic region for the unauthorized network access event, wherein the unique bounded geographic region is constructed using a rules-based approach based on an underlying geography associated with the geographic location and one or more characteristics of the unauthorized network access event;
identifying, by monitoring circuitry of the apparatus, a second network-connected device within the unique bounded geographic region, the first network-connected device being different than the second network-connected device;
obtaining information describing a current instruction set of the second network-connected device;
determining that the second network-connected device comprises an instruction set susceptible to the type of unauthorized network access event that occurred at the first network-connected device;
generating, by abatement circuitry of the apparatus, a reconfiguration instruction set based on the type of unauthorized network access event that occurred at the first network-connected device and the unique bounded geographic region associated with the type of unauthorized network access event;
transmitting to the second network-connected device the reconfiguration instruction set before the type of unauthorized network access event occurs at the second network-connected device;
determining, after transmission of the reconfiguration instruction set, whether the second network-connected device has performed a reconfiguration in accordance with the reconfiguration instruction set; and
in response to determining that the second network-connected device has performed a reconfiguration in accordance with the reconfiguration instruction set, changing a network access rule set associated with the second network-connected device, wherein the change of the network access rule set indicate one or more of: reduced fees charged with network access, reduced fees for services provided by a service provider, improved network access, or increased speed with which communications are performed via the network.

2-3. (canceled)

4. The method of claim 1, further comprising:
in response to determining that the second network-connected device has not performed a reconfiguration in accordance with the reconfiguration instruction set, adding an identification of the second network-connected device to an index of non-compliant devices.

5. The method of claim 1, wherein determining whether the second network-connected device has performed a reconfiguration in accordance with the reconfiguration instruction set comprises:
receiving an event data set from the second network-connected device; and
performing a compliance verification procedure on the received event data set.

6. The method of claim 5, further comprising, based at least in part on the compliance verification procedure performed on the received event data set, assigning a score associated with a susceptibility of the second network-connected device to one or more types of unauthorized network access events.

7. The method of claim 1 further comprising: generating a structured object storing an indication of one or more unique bounded geographic regions associated with the type of unauthorized network access event, the geographic location associated with the type of unauthorized network access event, or a location of the second network-connected device.

8. The method of claim 1, wherein the network access event data object further comprises an unauthorized network access event data set, wherein the unauthorized network access event data set comprises information extracted from one or more real-time data streams.

9. The method of claim 1, wherein the reconfiguration instruction set comprises a set of authentication protocols associated with the type of unauthorized network access event.

10. The method of claim 9, wherein the reconfiguration instruction set comprises a set of network authentication credentials associated with the type of unauthorized network access event.

11. The method of claim 1, wherein the second network-connected device is a point-of-sale terminal, and wherein the method further comprises initiating installation of the reconfiguration instruction set at the point-of-sale terminal.

12. An apparatus for dynamically disseminating, for installation at network-connected devices, reconfiguration instruction sets aimed at reducing unauthorized network access events, the apparatus comprising:
communications circuitry configured to receive a network access event data object from a first network-connected device, wherein the network access event data object identifies a type of an unauthorized network access event and a geographic location associated with the type of unauthorized network access event;
assessment circuitry configured to extract, from the network access event data object, information identifying the geographic location associated with the type of unauthorized network access event;
mapping circuitry configured to determine, a unique bounded geographic region for the unauthorized network access event, wherein the unique bounded geographic region is constructed using a rules-based approach based on an underlying geography associated with the geographic location and one or more characteristics of the unauthorized network access event;
monitoring circuitry configured to identify a second network-connected device within the unique bounded geographic region, the first network-connected device being different than the second network-connected device; obtain information describing a current instruction set of the second network-connected device; and determine that the second network-connected device comprises an instruction set susceptible to the type of unauthorized network access event that occurred at the first network-connected device;
abatement circuitry configured to generate a reconfiguration instruction set based on the type of unauthorized network access event that occurred at the first network-connected device and the unique bounded geographic region associated with the type of unauthorized network access event;
wherein the apparatus is further configured to transmit the reconfiguration instruction set to the second network-connected device before the type of unauthorized network access event occurs at the second network-connected device; determine, after transmission of the reconfiguration instruction set, whether the second network-connected device has performed a reconfiguration in accordance with the reconfiguration instruction set; and
in response to determining that the second network-connected device has performed a reconfiguration in accordance with the reconfiguration instruction set, change a network access rule set associated with the second network-connected device, wherein the change of the network access rule set indicate one or more of: reduced fees charged with network access, reduced fees for services provided by a service provider, improved network access, or increased speed with which communications are performed via the network.

13-14. (canceled)

15. The apparatus of claim 12, wherein the apparatus further comprises verification circuitry configured to determine whether the second network-connected device has performed a reconfiguration in accordance with the reconfiguration instruction set by receiving an event data set from the second network-connected device; and performing a compliance verification procedure on the received event data set.

16. The apparatus of claim 15, wherein the apparatus is further configured to, based at least in part on the compliance verification procedure performed on the received event data set, assigning a score associated with a susceptibility of the second network-connected device to one or more types of unauthorized network access events.

17. The apparatus of claim 12, wherein the apparatus is further configured to generate a structured object storing an indication of one or more unique bounded geographic regions associated with the type of unauthorized network access event, the geographic location associated with the type of unauthorized network access event, or a location of the second network-connected device.

18. The apparatus of claim 12, wherein the network access event data object further comprises an unauthorized network access event data set, wherein the unauthorized network access event data set comprises information extracted from one or more real-time data streams.

19. The apparatus of claim 12, wherein the reconfiguration instruction set comprises a set of authentication protocols associated with the type of unauthorized network access event.

20. The apparatus of claim 19, wherein the reconfiguration instruction set comprises a set of network authentication credentials associated with the type of unauthorized network access event.

21. The apparatus of claim 12, wherein the second network-connected device is a point-of-sale terminal, and wherein the apparatus is further configured to initiate installation of the reconfiguration instruction set at the point-of-sale terminal.

22. A non-transitory computer-readable storage medium for dynamically disseminating, for installation at network-connected devices, reconfiguration instruction sets aimed at reducing unauthorized network access events, the non-transitory computer-readable storage medium storing instructions that, when executed, cause an apparatus to:
receive, by communications circuitry of an apparatus, a network access event data object from a first network-connected device, wherein the network access event data object identifies a type of an unauthorized network access event and a geographic location associated with the type of unauthorized network access event;
extract, by assessment circuitry of the apparatus and from the network access event data object, information identifying the geographic location associated with the type of unauthorized network access event;
determine by mapping circuitry of the apparatus a unique bounded geographic region for the unauthorized network access event, wherein a size and shape of the unique bounded geographic region is constructed using a rules-based approach based on an underlying geography associated with the geographic location and one or more characteristics of the unauthorized network access event;
identify, by monitoring circuitry of the apparatus, a second network-connected device within the unique bounded geographic region, the first network-connected device being different than the second network-connected device;
obtain, by monitoring circuitry of the apparatus, information describing a current instruction set of the second network-connected device;
determine, by monitoring circuitry of the apparatus, that the second network-connected device comprises an instruction set susceptible to the type of unauthorized network access event that occurred at the first network-connected device;
generate, by abatement circuitry of the apparatus, a reconfiguration instruction set based on the type of unauthorized network access event that occurred at the first network-connected device and the unique bounded geographic region associated with the type of unauthorized network access event;
transmit to the second network-connected device of the reconfiguration instruction set before the type of unauthorized network access event occurs at the second network-connected device;
determine, after transmission of the reconfiguration instruction set, whether the second network-connected device has performed a reconfiguration in accordance with the reconfiguration instruction set; and
in response to determining that the second network-connected device has performed a reconfiguration in accordance with the reconfiguration instruction set, change a network access rule set associated with the second network-connected device, wherein the change of the network access rule set indicate one or more of: reduced fees charged with network access, reduced fees for services provided by a service provider, improved network access, or increased speed with which communications are performed via the network.

23. (canceled)

24. (canceled)

25. The method of claim 1, wherein the construction of the unique bounded geographic region is particular to the one or more characteristics of the unauthorized network access event.

26. The method of claim 25, wherein determining the unique bounded geographic region comprises generating a unique boundary of the bounded geographic region, wherein the unique boundary is based on the one or more characteristics of the unauthorized network access event and the underlying geography associated with the geographic location.
